(19) United States
(12) Patent Application Publication
(10) Pub. No.: US 2012/0214408 A1
(43) Pub. Date: Aug. 23, 2012

(54) Cellular Phone Ignition Interlock Device

(76) Inventor: Justin T. Chronister, El Reno, OK (US)

(21) Appl. No.: 13/401,392

(22) Filed: Feb. 21, 2012

Related U.S. Application Data
(60) Provisional application No. 61/444,752, filed on Feb. 20, 2011.

(51) Int. Cl. H04W 88/02; H04W 12/00

(52) U.S. Cl. 455/26.1; 455/557

(57) ABSTRACT

The present invention is aimed at preventing cell phone use by a driver of a vehicle. The present invention accomplishes this by physically isolating a cell phone so that the driver cannot use the cell phone but for a hands-free device. Upon docking of the cellular phone into the present invention, the authorized driver is permitted to operate the vehicle. Although the system allows multiple designated vehicle operators, it only allows cell phones of registered drivers to activate the ignition, thus also serving as a deterrent to vehicle theft.

### CONTINUITY DATA

This is a non-provisional application of provisional application No. 61,444,752 filed on Feb. 20, 2011 and priority is claimed thereto.

### FIELD OF THE INVENTION

The present invention is aimed at preventing cell phone use by a driver of a vehicle. The present invention accomplishes this by physically isolating a cell phone so that the driver cannot use the cell phone but for a hands-free device. Upon docking of the cellular phone into the present invention, the authorized driver is permitted to operate the vehicle. Although the system allows multiple designated vehicle operators, it only allows cell phones of registered drivers to activate the ignition, thus also serving as a deterrent to vehicle theft.

### BACKGROUND OF THE INVENTION

An estimated twenty-five percent of vehicle accidents can be attributed to the driver's use of a cell phone, potentially making a driver up to six times more likely to get in an accident compared to driving while intoxicated.

When driving a vehicle, talking on a cell phone can be distracting, if not fatal. Unlike listening to the radio or conversing with other passengers, operating a cell phone becomes something that must be done quickly to answer a call or hang up a call. Moreover, the very essence of operating a cell phone means that second calls must be identified and accepted or rejected, not to mention volume adjustments, dealing with dropped calls, text messages, and even emails. Some users even use their phones to read the news while driving! In short, use of a cell phone while driving greatly increases the chance for a collision to occur.

Advanced by increasing societal concern, state governments are enacting more and more legislation in an attempt to curtail the use of handheld cellular devices by drivers, both experienced and novice. At the time of this writing eight states, Washington D.C., and the Virgin Islands have prohibited all drivers from using any handheld device while driving (although hands-free devices are permitted). Twenty-eight states have banned handheld device usage by novice drivers and most states are moving to put a complete ban on texting while driving. Although these laws have been put into effect, there is still ambiguity surrounding their enforceability.

For example, some laws cannot be enforced unless a vehicle operator appears to be operating the vehicle in a dangerous manner. A policeman, even if he sees a vehicle operator holding a cell phone to his head, cannot stop the vehicle operator in some jurisdictions if the vehicle operator is not swerving, etc. when observed. Of course, a collision could happen at any time, but the policeman can only cite the vehicle operator if swerving or speeding is occurring, and then the cell phone use can be the basis for a further citation.

Some vehicles have tinted windows that make observing the vehicle operator nearly impossible, so cell phone use while driving cannot be easily monitored. Even the general concept of observing a vehicle operator is dangerous in and of itself, since a policeman cannot maintain safe driving while trying to observe if a cell phone is being held to a vehicle operator's head in a nearby vehicle.

In short, there is a need for a way to ensure that vehicle operators do not hold cell phones while driving. Talking on a cell phone is no more distracting then talking to a passenger in a vehicle; however, as noted above, the operation of the cell phone is a frequent cause of collisions. And, while laws have been enacted to combat cell phone use while driving, enforcing those laws becomes difficult for all the reasons enumerated above.

There are several patents that aim at regulating vehicle operator conduct, but none truly meet the need of ensuring that vehicle operators do not hold cell phones while driving.

The use of ignition interlock technology is well known, however the use of this technology is generally related to restricting an intoxicated driver from operating a vehicle. For example, U.S. Pat. No. 7,256,700 is for an “Ignition Interlock Device and Method” issued to Ruocco et al. on Aug. 14, 2007. Ruocco et al. is designed to take a sample of a driver's breath, test it to determine the driver's blood alcohol level, and impede vehicle ignition if the blood alcohol level is above a pre-determined threshold. Unlike the present invention, Ruocco et al. impedes vehicle ignition based upon blood alcohol level, whereas the present invention impedes vehicle ignition based on cell phone non-usage.

Similarly, U.S. Pat. No. 4,689,603 is for a “Vehicle Ignition and Alarm System” issued to Conigliaro et al. on Aug. 25, 1987. Conigliaro et al. describes a digital code-controlled ignition and security system for a vehicle, including an alcohol-detector device for preventing ignition when a predetermined alcohol level is detected in the breath of the operator. Unlike the present invention, Conigliaro et al. impedes vehicle ignition if a driver is intoxicated, whereas the present invention impedes vehicle ignition if a cell phone is not placed in a dock at the time of ignition.

Numerous devices offer a potential solution to prevent vehicle cell phone usage, but all known devices at this point attempt to solve the problem in a different fashion. One device is discussed in U.S. Pat. No. 6,978,146, “Device for Blocking Cellular Phone Signals,” issued to Yardman on Dec. 20, 2005. Yardman's is a device for blocking cell phone signals in a vehicle or another predetermined area. Unlike the present invention, Yardman deters cell phone usage in a vehicle by blocking signals, whereas the present invention deters cell phone usage in a vehicle by other means.

Another cell phone usage deterrent is identified in U.S. Pat. No. 7,123,874. This patent is for a “Cellular Phone Blocker” issued to Brennan on Oct. 17, 2006, which details a jamming device that can be retrofitted into the electrical system of a motor vehicle. The jamming device is mounted within a dashboard of a motor vehicle, and transmits radio frequency jamming signals in order to block reception by a cell phone within the vehicle. The jamming signals are transmitted when the ignition switch is on, and the jamming signals cease to issue when the ignition switch is not on. Unlike the present invention, Brennan issues a jamming signal to prevent the use of a cell phone or other wireless device in an automobile, whereas the present invention deters the use of a cell phone or other wireless device in the automobile without the use of a jamming signal.

Another signal inhibitor is discussed in U.S. Publication No. 2002/0102968, which is a device for “Wireless Telecommunications Signal Inhibition” issued to Arend et al. on Aug. 1, 2002. Arend et al. is an apparatus that blocks the use of a cell phone or other wireless device within a vehicle by employing sensors that produce a noise signal. Unlike the present invention, Arend et al. transmits a signal to impede the use of wireless devices in a vehicle, whereas the present invention deters the use of wireless devices in a vehicle by other means.

U.S. Pat. No. 6,771,946 is for “Method of Preventing Cell Phone Use While Vehicle is in Motion” issued to Oyaski on Aug. 3, 2004. Oyaski prevents a driver of a vehicle from using a cell phone while said vehicle is in forward motion or reverse motion, by emitting a signal to block cell phone usage when the motor vehicle is placed in gear. Unlike the present invention, Oyaski is linked to the vehicle transmission, whereas the present invention is linked to the vehicle's ignition. Also, Oyaski emits a signal to block cell phone usage, whereas the present invention does not emit a blocking signal to deter cell phone usage.

U.S. Pat. No. 6,496,703 is for “System for Disabling Wireless Communication Devices” issued to da Silva on Dec. 17, 2002. Da Silva is a method of controlling operational capabilities of wireless communication devices, enabling a user to monitor the identities and disable the operational capabilities of wireless communication devices in a moving zone. Unlike the present invention, da Silva impedes the operation of wireless communications devices in a vehicle, whereas the present invention impedes the usage of a wireless communications device in a vehicle without actually impeding the operation of the device.

### SUMMARY OF THE INVENTION

As a solution to the above-mentioned problem, the Cellular Phone Ignition Interlock Device (CID) is proposed as the present invention. The present invention limits the distractions caused by cellular devices by requiring that the driver dock his or her cell phone before the vehicle can be started and while the vehicle is in transit.

The present invention is designed to restrict the vehicle operator from handling his cellular phone while driving. In order to close the vehicle's ignition circuit, the driver's cell phone must be docked to the present invention. A matching radio-frequency identification (RFID) chip placed on the phone must be detected in order for the vehicle to be started. Once the vehicle is started, the cellular phone may not be removed from the present invention without such action being recorded in its USB memory and, for some cell phone models, a message being sent to a monitoring third party. Additionally, upon unauthorized removal, the vehicle's hazard lights will turn on and remain in operation until the phone is re-docked.

Although there is an obvious need for a cellular device while in transit, most current charging devices only encourage the act of inappropriate cellular phone usage while driving. Due to their long cords, drivers generally have the ability to operate all features of their cell phone while it is still attached to the charger. Serving as a hub for current USB compatible chargers, the present invention requires that the phone be stationary and inaccessible while the vehicle is in transit. (Other versions of the present invention may not require the use of a separate charger, in that more customizable versions could be designed to be specific to a particular cell phone model.)

The present invention will communicate with the vehicle of the driver, and upon docking of the cellular phone, will permit the authorized driver to operate the vehicle. Although the system allows multiple designated vehicle operators, it only allows cell phones of registered drivers (those with a compatible RFID chip) to activate the ignition, thus also serving as a vehicle theft deterrent. In case the driver has misplaced his cell phone or in the case of a system malfunction, a back-up PIN code may be entered on the keypad of the present invention so that the vehicle may be operable. If the back-up PIN code is entered, the occurrence is recorded in the present invention's USB memory, and for some cell phone models the present invention will send a message to a monitoring third party.

### BRIEF DESCRIPTION OF THE DRAWINGS

FIG. 1 is the back view of the present invention.

FIG. 2 details the back view of the present invention with the electromagnetically hinged doors and back panel removed.

FIG. 3 illustrates the prospective side view of the present invention.

FIG. 4 shows the front view of the present invention.

FIG. 5 shows the rear view of the present invention with the electromagnetically hinged doors open.

FIG. 6 is a diagrammatic view of the operational components inherent to the appropriate function of the present invention.

FIG. 7 schematically represents the preferred embodiment of the operational sequence of the present invention.

### DETAILED DESCRIPTION OF THE PREFERRED EMBODIMENT(S)

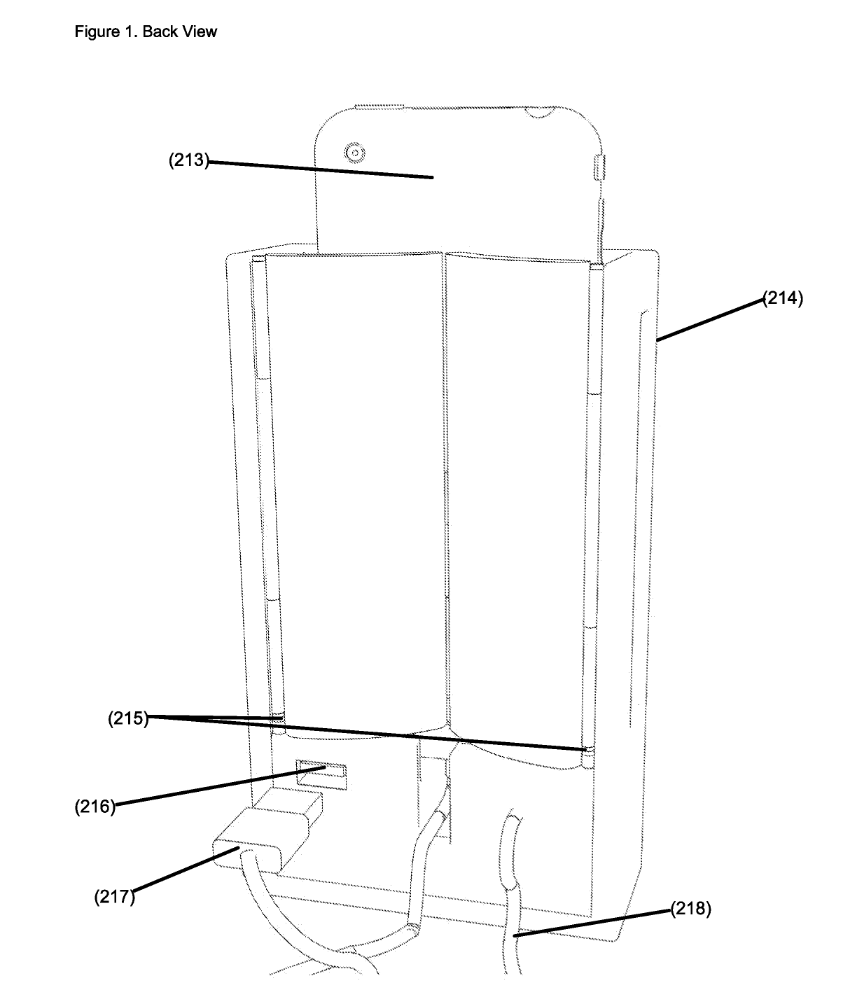

FIG. 1 is the back view of the present invention. The cellular device (213) is inserted into the present invention and held securely by the electromagnetically hinged doors (215). Also detailed is the rear USB port (216) used to connect the cellular device (213) to a factory-provided USB charger (217). The wiring harness (218) leads to the normally closed starter relay (235) (not shown in FIG. 1), vehicle power source (238) (not shown in FIG. 1), and hazard relay (233) (not shown in FIG. 1).

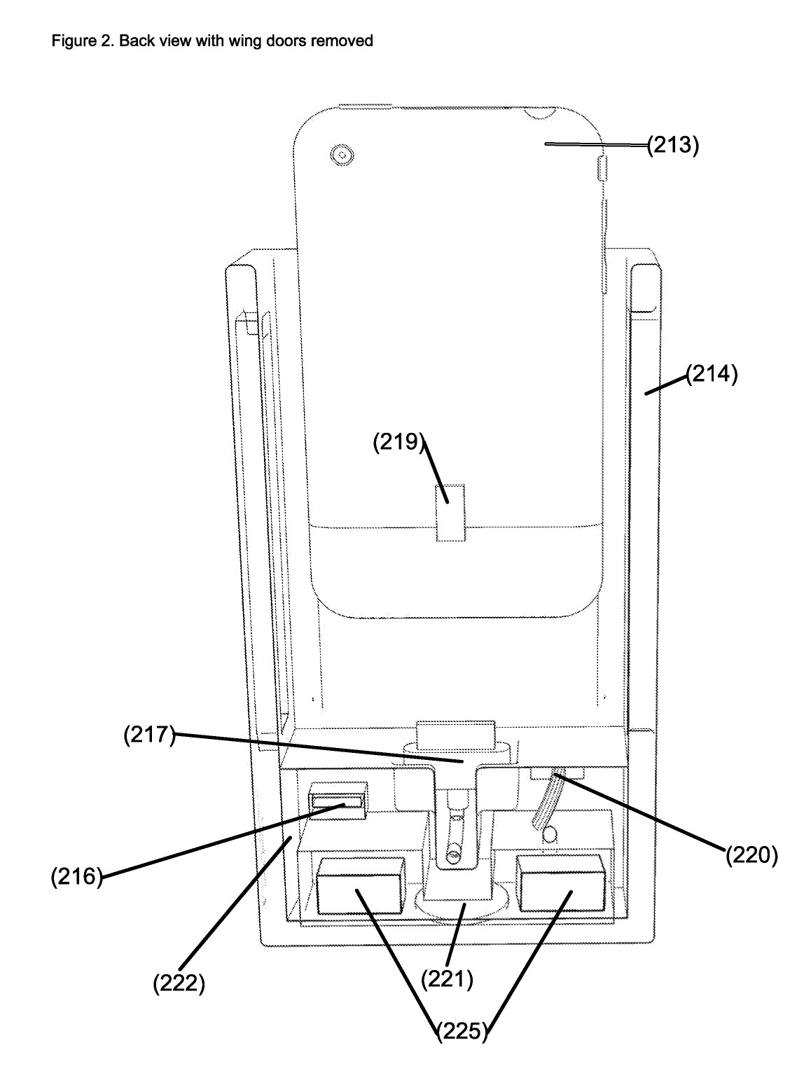

FIG. 2 details the back view of the present invention after removing the electro-magnetically hinged doors (215) (not shown in FIG. 2, see FIG. 1). The RFID chip (219) is shown affixed to the back of the cellular device (213). A back view of the front USB drive (220) is also shown. The space for the rear USB port (216) is also shown, as well as the lower cavity space (222), in which resides an RFID reader (221) (not visible in FIG. 2), USB memory (225) (not visible in FIG. 2), and other optional hardware.

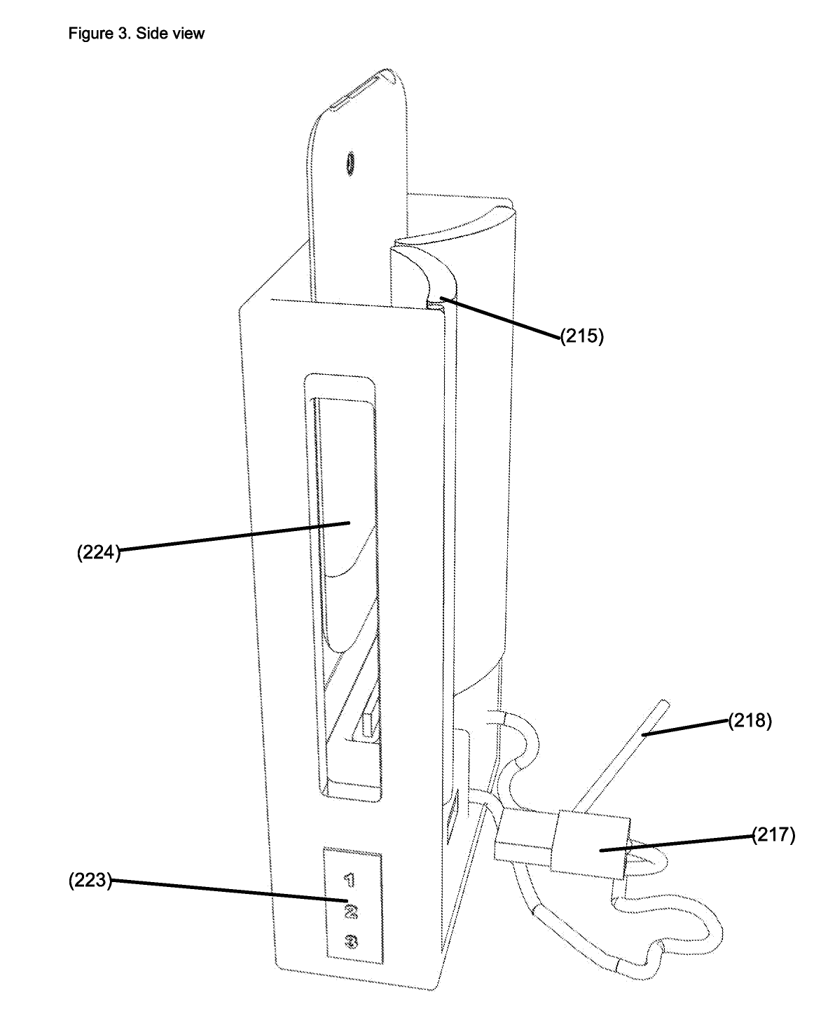

FIG. 3 provides a side view of the present invention. The normally closed starter relay (235) (not shown in FIG. 3) override coded 3-digit PIN switch (223) is located on the side opposite the driver and toward the bottom of the device. Also shown is the open side port window (224) which is used for side charged cellular devices and side mounted accessories. Also identified are the electromagnetically hinged doors (215), the factory USB charger (217), and the wiring harness (218) leading to the normally closed starter relay (235) (not shown in FIG. 3), vehicle power source (238) (not shown in FIG. 3), and hazard relay (233) (not shown in FIG. 3).

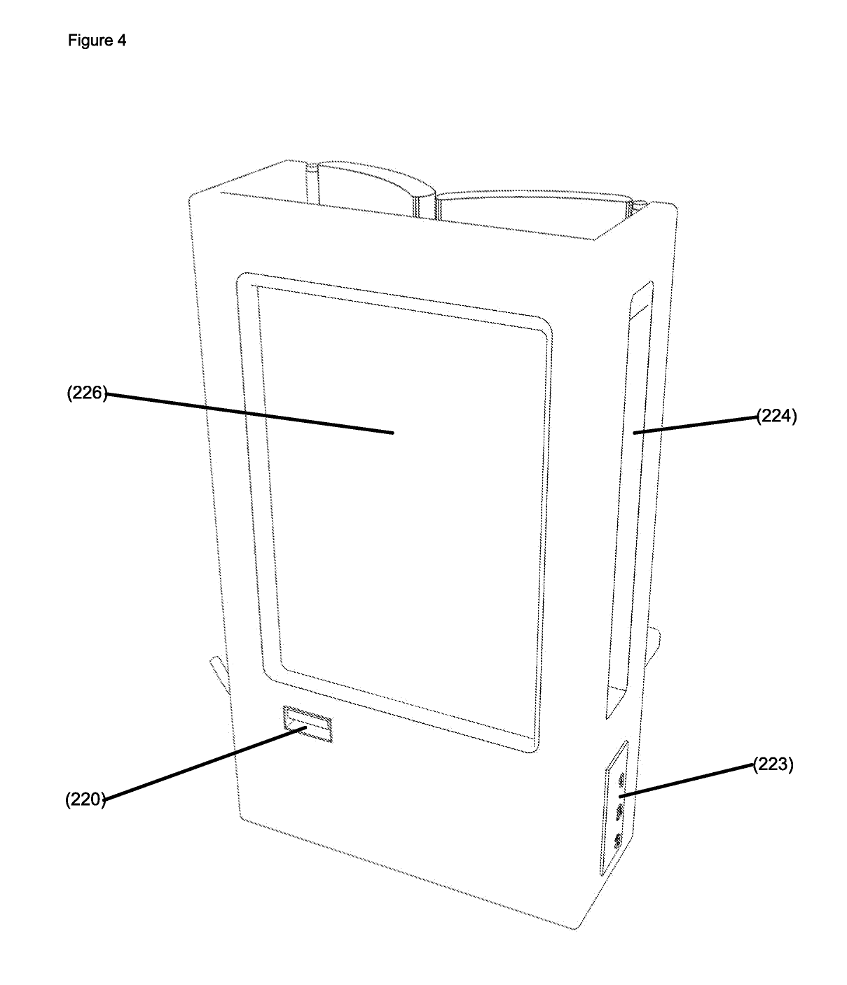

FIG. 4 illustrates the front view of the present invention with no phone inserted. The transparent window (226) allows the vehicle operator to view the cellular device (213) (not shown in FIG. 4, see FIG. 1) but does not permit manual interaction. Also shown is a different perspective of the front USB drive (220), the PIN switch (223), and open side port window (224).

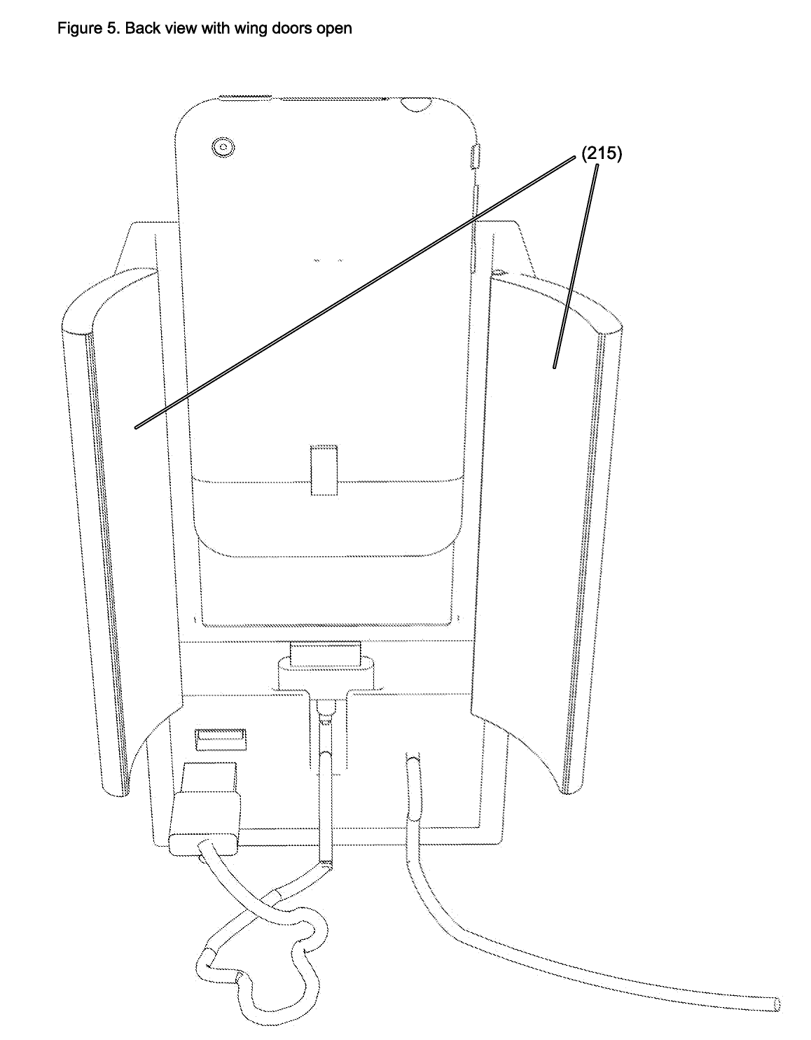

FIG. 5 is a rear view of the present invention with the electromagnetically hinged doors (215) open.

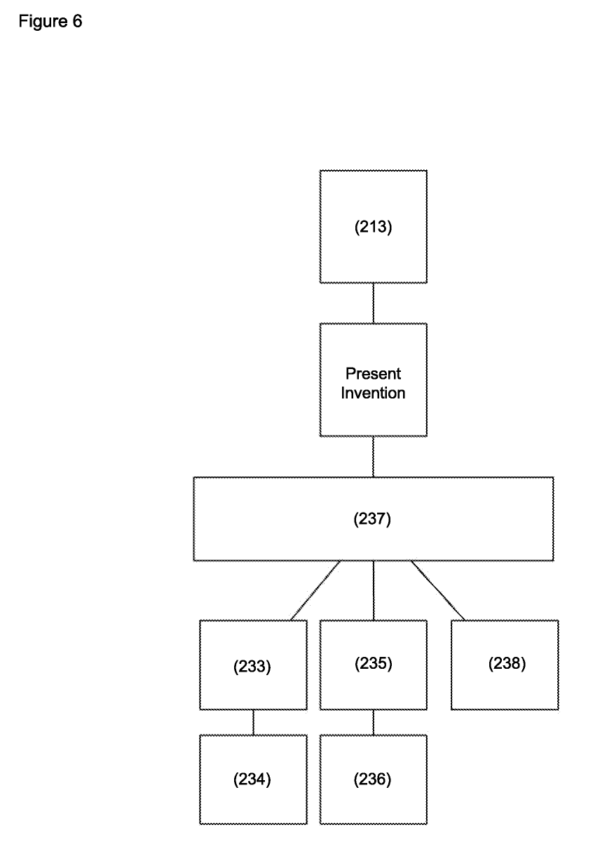

FIG. 6 is a schematic diagram of the present invention and other necessary components. The cellular device (213) is housed within the present invention. Upon RFID matching, the present invention sends a start signal via the onboard interface (237) to the normally closed starter relay (235) which allows the ignition (236) to function properly. Upon unauthorized removal of the cellular device (213), the present invention onboard interface (237) communicates with the hazard relay (233), which in turn operates the hazard lights (234) of the vehicle. The onboard interface (237) takes the logic generated by a chip and converts it to a signal that can be relayed and understood by the normally closed starter relay (235) and the hazard relay (233). The present invention onboard interface (237) is connected to the vehicle power source (238).

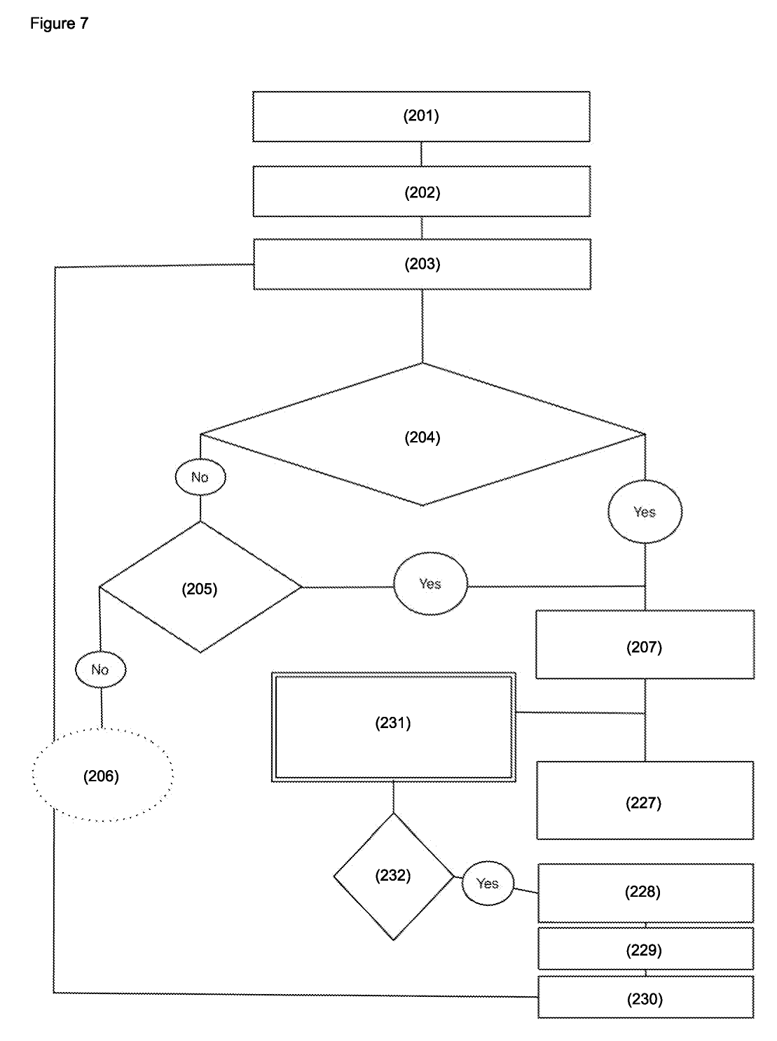

FIG. 7 schematically represents the preferred embodiment of the operational sequence of the present invention. The vehicle switch is placed in the “key on” position (201). With the ignition engaged, the RFID reader circuit is energized (202). The RFID reader scans for matching RFID frequency and seeks the RFID chip (203). The RFID chip is checked to see if it is within range or if it matches that of a predesignated device (204). If the RFID chip is either not within range or does not match that of a predesignated device (204), then the normally closed starter relay override coded 3-digit PIN switch must be used to initiate the matching override event (205). If there is no RFID matching and the override coded 3-digit PIN switch is not utilized (205), then no start signal is sent and the vehicle will not start (206). If a matching override event (205) does occur, then the electromagnetically hinged doors engage to lock out the cellular device (207). A start signal (5 vdc+) is then sent to the normally closed starter relay to allow the car to start (227) and the date and time of occurrence is stored (228) in the USB memory. If the vehicle is turned off (229) a predesignated lag time must elapse (230) to permit the electromagnetically hinged doors to open and to allow the cellular device to be reinserted into the present invention. If the RFID chip is within range and the RFID reader recognizes it as authorized, then the electromagnetically hinged doors are engaged to lock the cellular device (213) in place. Once the cellular device is in place a start signal (5 vdc+) is sent to the normally closed starter relay to allow the car to start (227). The present invention is then placed in closed circuit monitoring mode (231). If the cellular device is removed from the present invention while the vehicle is in use (232), then the date and time of occurrence is stored (228) in the USB memory, the electromagnetically hinged doors will close further to restrict replacement of the cellular device, and the vehicle's hazard lights will be turned on and remain in operation until the vehicle is turned off (229). If the vehicle is turned off (229) a predesignated lag time must elapse (230) to permit the electromagnetically hinged doors to open and to allow the cellular device to be reinserted into the present invention.

Furthermore, it is additionally envisioned that embodiments of the present invention preferably include a conventional RFID reader, and that the RFID chip that is read by the reader is preferably placed on the back panel of a cellular device via an adhesive. The adhesive serves as a form of anti-tampering device, which bonds the RFID chip to the cellular device in such a way that removal of the RFID chip would render the chip inoperable. The anti-tamper process proceeds as follows:

Given that the is equipped with a passive RFID reader, the RFID reader is designed to only react when the phone is in the cradle. The sticker-based RFID chip is affixed to the back of the phone at very close range (˜1 inch) via an adhesive. The reader in the cradle will only react to the programmed ID number contained in the RFID transmitter. Next, once the phone with an affixed RFID chip is placed in the cradle and power is applied to the cradle, the “phone inserted” event is recorded into a digital log along with the date and time (GPS location is also a possible logging option). Whenever power is lost to the cradle, a “power off” event is recorded in the log as well. When power is supplied via the vehicle, a “power on” event is recorded. If a RFID ID number is different then the ID number expected by the RFID reader, a “ID exception event” is recorded in the log. If the RFID sticker is tampered with or removed, it will cease to operate as if an individual attempts to remove or move the sticker, a seal is broken that contains a closed-loop circuit. The destruction of this circuit loop leaves the circuit open, indicating the RFID chip was tampered with. The events log may be retrieved via a thumb drive or by optionally transmitting data wirelessly to a third party. The present invention is difficult to circumvent by an average individual because of the integration of the RFID chip onto the cellular device. Any attempt to remove the RFID chip from the cellular device would certainly result in its destruction. If the RFID chip is unable to communicate with the RFID reader, then the ignition circuit can only be opened via the PIN code.

Additionally, the present invention continues to function without power supplied from the cellular device. Thus, the present invention may be employed even in the event that the cellular device has a drained battery.

In the even that the vehicle driver pried the magnetic doors open and attempted to reinsert the phone after use, the hazard lights would still not be deactivated until the vehicle is turned completely off. After the vehicle is turned off, a predesignated time period (customizable by monitoring third party) must elapse or the PIN code must be entered, in order to re-start the vehicle.

In some embodiments of the present invention, it is envisioned that the electromagnetically hinged doors found in front of the cellular device (when the cellular device is in the dock) are preferably transparent, so that the driver may still view the screen of the cellular device while driving. It is to be understood that the cellular device dock is the cradle of the present invention. It is also to be understood that the present invention is envisioned to be designed to accommodate a vast variety of cellular devices, and is not solely limited to traditional cellular phones.

Alternate embodiments of the present invention include variations or instantiations that may be incorporated by a vehicle manufacturer, at the factory, in order to seamlessly integrate the present invention into the dashboard of a vehicle. In this manner, a hinged, lockable door may open up, out of the dash of the vehicle, in order to accept the cellular device. Subsequently, the door closes and locks the cellular device within the dash of the vehicle, making it very hard to tamper with. Bluetooth technology, conventionally equipped in vehicles from the factory, may be employed in this embodiment of the present invention; however, this eliminates the option of the driver's capacity to interact with the phone directly at all while the vehicle is in motion.

It is to be understood that the present invention is not limited to the embodiments as described above. It should be understood that there may be variations in the present invention that are not limited to the detailed description of the embodiment, but still capture the essence of the invention as dictated in the following claims.

I claim:

1. A method for preventing equipment having an operator seat from being operated comprising:
connecting a cellular device dock to an ignition of the equipment;
inserting a cellular device into the cellular device dock; and
preventing operation of the equipment when the cellular device is not inserted into the cellular device dock.

2. The method of claim 1, wherein said preventing operation of the equipment when the cellular device is not inserted into the cellular device dock comprises preventing the equipment from being started.

3. The method of claim 1, wherein the cellular device inserted into the cellular device dock must be that of a predetermined, authorized user.

4. The method of claim 1, wherein said inserting a cellular device into the cellular device dock conveys information regarding the removal of the cellular device subsequent to ignition of the equipment to a monitoring third party via a local device.

5. The method of claim 1, wherein the cellular device dock serves as a cellular device charger or as a hub for a cell phone charger.

6. The method of claim 1, wherein said inserting a cellular device into the cellular device dock is inhibiting the operation of the cellular device.

7. An ignition interlock device for a vehicle comprising a cellular device dock that prevents the operation of said vehicle when a cellular device is not placed within the dock.

8. The ignition interlock device of claim 7 further serving as a cellular device charger.

9. The ignition interlock device of claim 7 further comprising a computer that conveys information to a local memory storage when a cellular device is removed.

10. The ignition interlock device of claim 7, further comprising a computer that conveys information regarding the removal of the cellular device subsequent to ignition of the equipment to a monitoring third party via local device storage.

11. The ignition interlock device of claim 7, wherein the cellular device is specifically authorized to allow operation of the vehicle in which it is placed.

12. The ignition interlock device of claim 7 further comprising a lock that limits the functionally of the phone by making it inaccessible to the operator when docked within the vehicle.

13. The method of claim 6, wherein said inhibiting the operation of the cellular device is immobilizing the cellular device via a locking mechanism.

14. The method of claim 3, wherein the cellular device is identified by using a matching RFID chip and a RFID reader.

15. The method of claim 14, wherein the matching RFID chip initiates a circuit to engage a lock.

16. The ignition interlock device of claim 7 wherein the cellular device dock activates a hazard light of a vehicle when an authorized cellular device is removed from said ignition interlock device.
